(19) United States
(12) Patent Application Publication
(10) Pub. No.: US 2008/0122342 A1
(43) Pub. Date: May 29, 2008

(54) LIGHT EMISSION DEVICE AND METHOD OF MANUFACTURING THE LIGHT EMISSION DEVICE

(76) Inventor: Sang-Hyuck Ahn, Yongin-si (KR)

Correspondence Address: CHRISTIE, PARKER & HALE, LLP, PO BOX 7068, PASADENA, CA, 91109-7068, US

(21) Appl. No.: 11/835,108

(22) Filed: Aug. 7, 2007

(30) Foreign Application Priority Data
Nov. 27, 2006 (KR) 10-2006-0117639

(51) Int. Cl. H01J 1/62; H01J 9/12

(52) U.S. Cl. 313/503; 445/49

(57) ABSTRACT

A light emission device and a method of manufacturing the light emission device are provided. A method of manufacturing a light emission device includes forming a first electrode on a substrate to have an active portion and a main pad extending along a first direction of the substrate, forming an insulating layer on the substrate while exposing at least a portion of the main pad, forming a second electrode layer on an entire surface of the substrate, and patterning the second electrode layer to form an active portion and a pad of a second electrode extending along a second direction of the substrate and to form a sub-pad on the main pad.

### CROSS-REFERENCE TO RELATED APPLICATION

This application claims priority to and the benefit of Korean Patent Application No. 10-2006-0117639, filed on Nov. 27, 2006, in the Korean Intellectual Property Office, the entire content of which is incorporated herein by reference.

### BACKGROUND OF THE INVENTION

1. Field of the Invention

The present invention relates to a light emission device and/or a method of manufacturing the light emission device.

2. Description of the Related Art

Any device that can emit light to an external side can be referred to as a light emission device. In one embodiment, a light emission device includes a front substrate on which a phosphor layer and an anode electrode are formed and a rear substrate on which driving electrodes and electron emission regions are formed. In this embodiment, the light emission device emits visible light by exciting the phosphor layer using electrons emitted from the electron emission regions.

The driving electrodes include scan and data electrodes that cross each other with an insulating layer interposed therebetween. Electrode pads extend from respective ends of the scan and data electrodes and are connected to respective circuit board assemblies.

In order to increase or maximize an area of a light emission surface within a limited size of the rear substrate, the electrode pads should be formed at an outermost edge of the rear substrate. When one of the scan and data electrodes is located under the insulating layer (also referred to as a lower electrode) and the other electrode is located above the insulating layer (also referred as an upper electrode), the pad of the lower electrode should not be covered with the insulating layer.

However, the insulating layer may invade (or cover) the pad of the lower electrode during a process for forming the insulating layer after the lower electrode is formed on the rear substrate if an alignment capability of a layer growth apparatus is not sufficient. In this case, since an exposed area of the pad of the lower electrode is reduced, there may be a contact error between the pad of the lower electrode and a flexible printed circuit (FPC).

In order to solve the above problem, an etching process may be added to remove a portion of the insulating layer, which invades the pad of the lower electrode. In this case, the pad of the lower electrode, however, may be damaged if an exposing time to an etching solution is not accurately controlled.

Moreover, in a process for forming the upper electrode by patterning an upper electrode layer deposited on the insulating layer using an etching solution, if the upper electrode layer is formed of a same material as the pad of the lower electrode layer and/or if the etching solution is a solution that can etch the pad of the lower electrode, the pad of the lower electrode, which is exposed out of the insulating layer, may be etched together with the upper electrode layer (and be damaged).

### SUMMARY OF THE INVENTION

An aspect of an embodiment of the present invention is directed to a light emission device having an improved pad structure for electrodes located under an insulating layer.

Another aspect of an embodiment of the present invention provides a light emission device adapted to reduce (or prevent) a contact error between a lower electrode pad and a flexible printed circuit, which may be caused by an invasion of an insulating layer to the lower electrode pad (e.g., caused by the insulating layer covering a portion of the lower electrode pad), and to suppress a damage of the lower electrode pad during a subsequent process.

In an exemplary embodiment of the present invention, a method of manufacturing a light emission device includes forming a first electrode on a substrate to have an active portion and a main pad extending along a first direction of the substrate, forming an insulating layer on the substrate while exposing at least a portion of the main pad; forming a second electrode layer on an entire surface of the substrate; and patterning the second electrode layer to form an active portion and a pad of a second electrode extending along a second direction of the substrate and to form a sub-pad on the main pad.

In one embodiment, the sub-pad is larger in area than the main pad.

In one embodiment, the main pad includes a main electrode layer and a sub-electrode layer covering the main electrode layer, and the sub-electrode layer is larger in area than the main electrode layer. The main electrode layer may be formed of a transparent conductive material, and the sub-electrode layer may be formed of chrome or chrome/aluminum/chrome.

In one embodiment, the second electrode layer is formed of chrome, molybdenum, and/or chrome/aluminum/chrome.

In one embodiment, the method further includes forming an additional insulating layer on the substrate while exposing at least a portion of the sub-pad, forming a third electrode layer on an entire surface of the substrate, and patterning the third electrode layer to form a third electrode on the additional insulating layer and to form an additional sub-pad on the sub-pad. The additional sub-pad may be larger in area than the sub-pad.

In another exemplary embodiment of the present invention, a light emission device includes a first substrate, a second substrate facing the first substrate, a first electrode located on a surface of the first substrate to face the second substrate and having a pad located on an edge portion of the surface of the first substrate, a second electrode located over the first electrode with an insulating layer interposed therebetween (the second electrode crossing the first electrode), and a phosphor layer located on a surface of the second substrate to face the first substrate. In this embodiment, the pad of the first electrode includes a main pad and a sub-pad partly contacting the main pad and located on the main pad, the sub-pad including substantially a same material as the second electrode.

In one embodiment, the sub-pad is larger in area than the main pad.

In one embodiment, the main pad includes a main electrode layer and a sub-electrode layer covering the main electrode layer, and the sub-electrode layer is larger in area than the main electrode layer. The main electrode layer may include a transparent conductive material, and the sub-electrode layer may include chrome or chrome/aluminum/chrome.

In one embodiment, the light emission device further includes an additional insulating layer located over the second electrode, a third electrode located on the additional insulating layer, and an additional sub-pad located on the sub-pad, the additional sub-pad being larger in area than the sub-pad and including substantially a same material as the third electrode.

In one embodiment, the light emission device further includes a plurality of electron emission regions located at a crossing region of the first electrode and the second electrode and an anode electrode located on a surface of the phosphor layer. The phosphor layer may be adapted to emit white light, the first and second substrates may be spaced apart from each other by a distance ranging from 5 to 20 mm, and the anode electrode may be applied with an anode voltage ranging from 10 to 15 kV. The phosphor layer may include red, green and blue phosphor layers, and a black layer may be located between the red, green and blue phosphor layers.

In one embodiment, the light emission device further includes a plurality of barrier ribs located between the first and second substrates to define a plurality of discharge cells, wherein the discharge cells are filled with discharge gas. The first electrode may include a first bus electrode extending in a first direction of the first and second substrates and a plurality of first transparent electrodes extending from the first bus electrode toward central portions of respective ones of the discharge cells, and the second electrode may include a second bus electrode extending in a second direction of the first and second substrates and a plurality of second transparent electrodes extending from the second sub electrode toward central portions of respective ones of the discharge cells.

In another exemplary embodiment of the present invention, a light emission device includes a substrate, a first electrode located on a surface of the substrate and having an active portion and a pad (the pad being on an edge portion of the surface of the substrate), a second electrode located over the first electrode and crossing the first electrode, and an insulating layer interposed between the first electrode and the second electrode. Here, the pad of the first electrode includes a main pad and a sub-pad partly contacting the main pad and located on the main pad, the sub-pad including substantially a same material as the second electrode.

In one embodiment, the light emission device further includes a plurality of electron emission regions located at a crossing region of the first electrode and the second electrode, and an anode electrode located over the first electrode and the second electrode, the anode electrode being for accelerating electrons emitted from the electron emission regions.

In one embodiment, the light emission device further includes a second substrate, a phosphor layer located on a surface of the second substrate to face the first and second electrodes, and a plurality of barrier ribs located with the phosphor layer on the surface of the second substrate to define a plurality of discharge cells. Here, the discharge cells are filled with discharge gas for a plasma discharge.

### BRIEF DESCRIPTION OF THE DRAWINGS

FIGS. 1A, 1B, 1C, 1D, 1E, 1F, 1G, and 1H are schematic views illustrating a method of manufacturing a light emission device according to a first embodiment of the present invention.

FIGS. 2A and 2B are schematic views illustrating a method of manufacturing a light emission device according to a second embodiment of the present invention.

FIGS. 3A, 3B, and 3C are schematic views illustrating a method of manufacturing a light emission device according to a third embodiment of the present invention.

FIG. 4 is a partially cut-away perspective view illustrating an internal structure of an active region in a light emission device according to an embodiment of the present invention.

FIG. 5 is a partially cut-away perspective view illustrating an internal structure of an active region in a light emission device according to another embodiment of the present invention.

FIG. 6 is a partially cut-away perspective view illustrating an internal structure of an active region in a light emission device according to another embodiment of the present invention.

FIG. 7 is a partial top plan view of first and second electrodes of the light emission device of FIG. 6.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Hereinafter, like reference numerals refer to like elements.

In addition, when an element is referred to as being “on” another element, it can be directly on the another element or be indirectly on the another element with one or more intervening elements interposed therebetween. By contrast, when an element is referred to as being “directly on” another element, there are no intervening elements present.

In exemplary embodiments of the present invention, all devices that emit light to an external side are regarded as light emission devices. Therefore, all display devices that transmit information by displaying symbols, letters, numbers, or images can be regarded as light emission devices. In addition, the light emission device can be used as a light source for providing (or emitting) light to a passive display panel (or a non-emissive display panel).

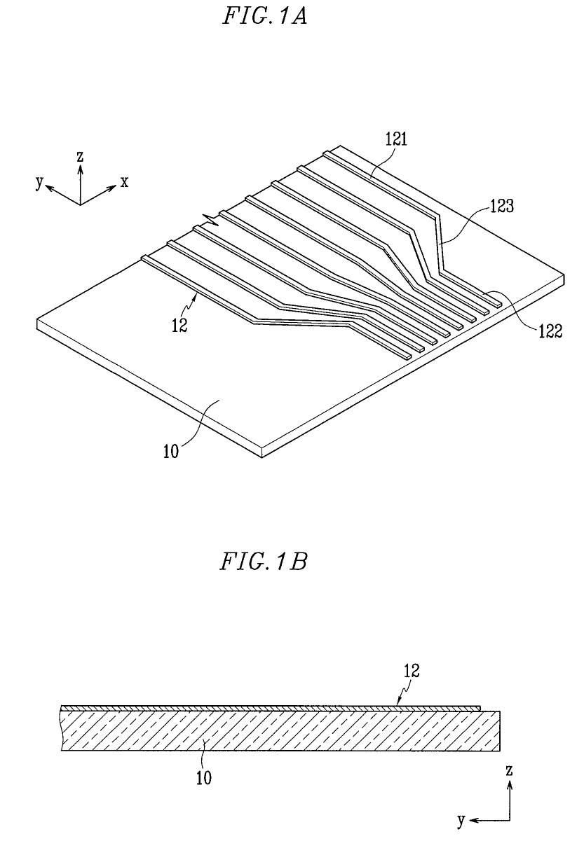

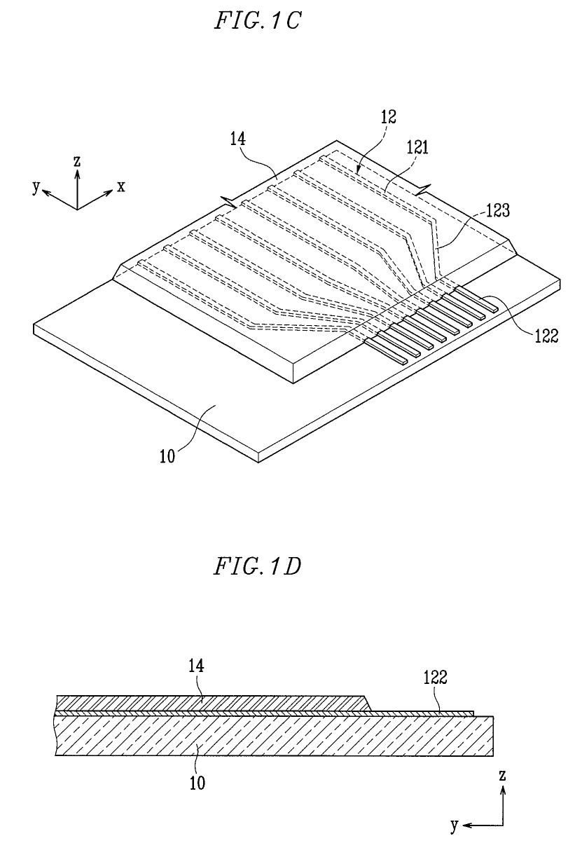

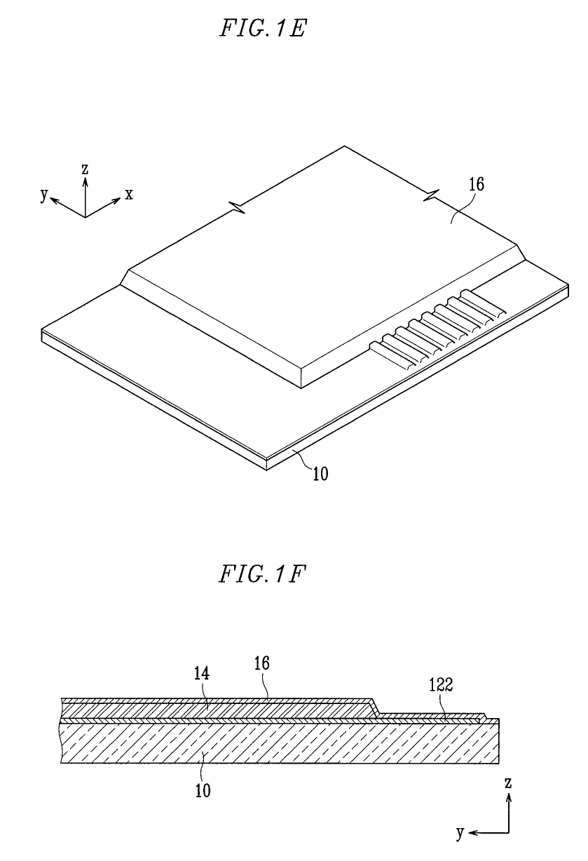

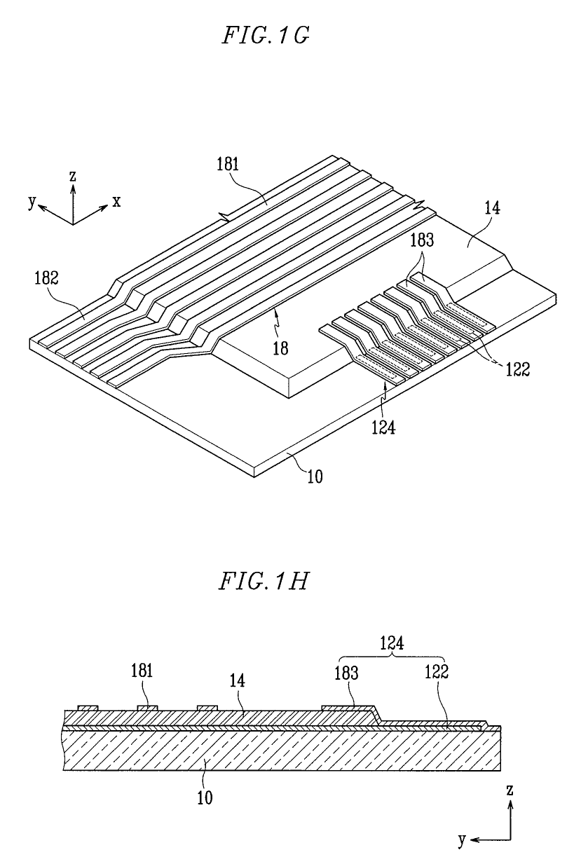

FIGS. 1A through 1H are schematic views illustrating a method of manufacturing a light emission device according to a first embodiment of the present invention.

Referring first to FIGS. 1A and 1B, a first electrode layer is formed on the substrate 10 and patterned to form first electrodes 12 extending in a first direction (a y-axis in the drawings) of the substrate 10. The substrate 10 is divided into an active region where visible light is emitted and an inactive region surrounding the active region. The first electrode 12 has an active portion 121 located in the active region and a main pad 122 located at an edge (or edge portion) of the substrate 10.

The main pads 122 may have a smaller electrode pitch than the active portions 121. To realize this, an oblique connecting portion 123 may be located between the active portion 121 and the main pad 122. The oblique connecting portion 123 is located at the inactive region. A width of the active portion 121 may be equal to or greater than that of the main pad 122. In the FIGS. 1A and 1B, an embodiment where the width of the active portion 121 is equal (or substantially equal) to that of the main pad 122 is illustrated as an example.

Referring to FIGS. 1C and 1D, an insulation material is deposited on the substrate 10 with a thickness (that may be predetermined) while allowing at least a portion of the main pads 122 to be exposed. The insulating layer 14 may be formed with a thickness less than 1 μm through a chemical vapor deposition process or with a thickness of about 2 to 3 μm through screen printing, drying, and baking processes.

In one embodiment of the present invention, the insulating layer 14 may be formed to fully expose the main pads 122. However, if the layer growth apparatus does not have a sufficient alignment capability, as shown in FIG. 1C, the insulating layer 14 may partly invade (or cover) the main pads 122. In this case, since a contact area between the main pads 122 and a flexible printed circuit is reduced, a contact error may occur.

Referring to FIGS. 1E and 1F, a conductive material is deposited on an entire surface of the substrate 10 to form a second electrode layer 16. The second electrode layer 16 is located on both of the active and inactive regions to cover the main pads 122 as well as the first electrodes 12. The second electrode layer 16 may be formed of chrome, molybdenum, and/or chrome/aluminum/chrome.

Referring to FIGS. 1G and 1H, the second electrode layer 16 is patterned to form the active portions 181 and pads 182. At this point, sub-pads 183 are formed above the respective main pads 122. The active portions 181 of the second electrodes 18 may cross the active portion 121 of the first electrode 12. The pads 182 of the second electrode 18 are arranged in parallel along the edge (or edge portion) of the substrate 10. The sub-pads 183 are spaced apart from the active portions 181 of the second electrodes 18 in order to prevent (or protect from) a short circuit therebetween. The sub-pads 183 cover the main pad 122 formed out of the insulating layer 14 and extend up to a part of a top surface of the insulating layer 14.

That is, each of the pads 124 of the first electrodes 12 includes the main pad 122 and the sub-pad 183 covering the main pad 122. The sub-pad 183 partly contacts the main pad 122 and is formed of a same material (or substantially the same material) as the second electrode 18. The insulating layer 14 is partly located between the main pad 122 and the sub-pad 183.

The sub-pads 183 are connected to the flexible printed circuit to be applied with a driving voltage from the flexible printed circuit. The driving voltage applied to the sub-pads 183 is transmitted to the active portions 121 of the first electrodes 12 through the main pads 122. As described above, the sub-pads 183 are formed of the same material (or substantially the same material) as the second electrodes 18 and patterned simultaneously with the second electrodes 18. However, since the sub-pads 183 are formed on the main pads 122, they function as the pads 124 for the first electrodes 12 rather than the second electrodes 18.

The sub-pads 183 function to prevent (or protect from) the contact error between the pads 124 and the flexible printed circuits by enlarging a contact area of the pads 124 with the flexible printed circuits. An area of the sub-pad 183 may be greater than that of the corresponding main pad 122. That is, a length and width of the sub-pad 183 are greater than those of the corresponding main pad 122.

In the present exemplary embodiment, if the second electrodes 18 are formed of a same material (or substantially the same material) as the first electrodes 12 and the second electrode layer 16 is patterned by an etching solution that can be used for etching the main pad 122, the pattern error of the main pads 112 can also be prevented (or reduced) by the sub-pads 183 during the process for patterning the second electrode 18.

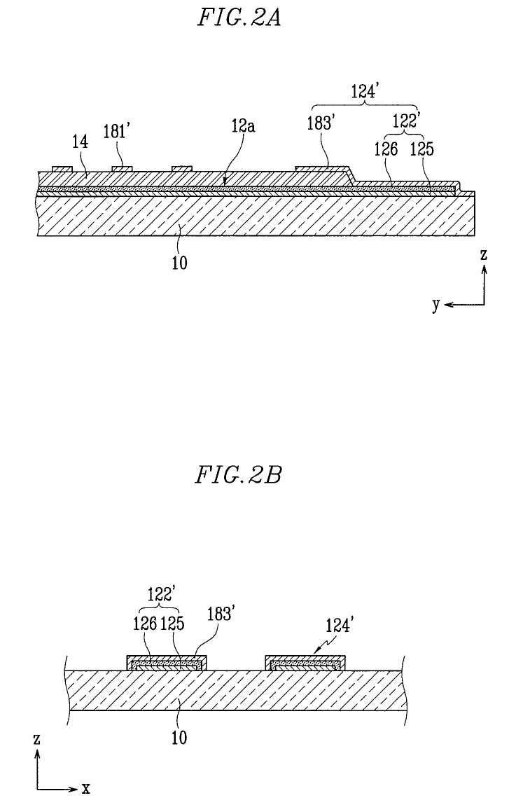

The following will describe a method of manufacturing a light emission device according to a second embodiment of the present invention with reference to FIGS. 2A and 2B.

Referring to FIGS. 2A and 2B, a main pad 122′ of each of first electrodes 12a is formed by forming a main electrode layer 125 using a transparent conductive material and forming a sub-electrode layer 126 on the main electrode layer 125 using metal having a resistivity lower than that of the main electrode layer 125.

An area of the sub-electrode layer 126 may be greater than that of the corresponding main electrode layer 125. The sub-electrode layer 126 functions to suppress a voltage drop by lowering a line resistance of the first electrode 12a. The main electrode layer 125 may be formed of indium tin oxide and the sub-electrode layer 126 may be formed of chrome, molybdenum, and/or chrome/aluminum/chrome.

A sub-pad 183′ may be larger than the sub-electrode layer 126 such that it can entirely cover the sub-electrode layer 126. In this case, the sub-pad 183′ prevents (or protects) the sub-electrode layer 126 from being exposed by a developing solution in a subsequent process and thus a battery (or oxidation/reduction or corrosive) phenomenon occurring at a first electrode pad 124′, particularly, at an aluminum layer of the sub-electrode layer 126 can be suppressed.

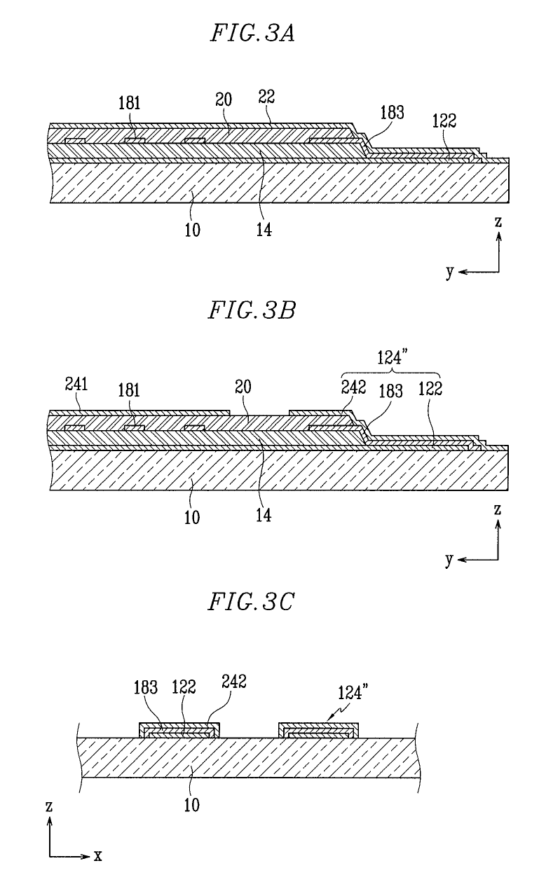

The following will describe a method of manufacturing a light emission device according to a third embodiment of the present invention with reference to FIGS. 3A through 3C. In the following description, for purposes of convenience, an insulating layer located between the first and second electrodes will be referred as a first insulating layer and a sub-pad of the second electrode will be referred as a first sub-pad.

A method of manufacturing a light emission device according to this exemplary embodiment further includes (1) forming a second insulating layer 20 on the first insulating layer 14 and the second electrodes 18 while partly exposing the first sub-pads 183 (see FIG. 3A), (2) forming a third electrode layer 22 on an entire surface of the substrate 10, and (3) forming a third electrode 241 on the second insulating layer 20 while forming second sub-pads 242 on respective first sub-pads 183 (see FIG. 3B) by patterning the third electrode layer 22.

The third electrode 241 may be formed on an entire surface of the active region and second sub-pads 242 are spaced apart from the third electrodes 241 to prevent (or protect form) a short circuit therebetween. The third electrode 241 and the second sub-pads 242 may be formed of chrome and/or molybdenum. The second sub-pad 242 contacts the first sub-pad 183. Therefore, the second sub-pad 242, the main pad 122, and the first sub-pad 183 constitute the first electrode pad 124″.

That is, in the present exemplary embodiment, the first electrode pad 124″ includes: the main pad 122; the first sub-pad 183 that is located on the main pad 122 and formed of the same material (or substantially the same material) as the second electrode 18; and the second sub-pad 242 that is located on the first sub-pad 183 and formed of a same material (or substantially the same material) as the third electrode 241. At this point, the second insulating layer 20 is partly located at a portion between the first and second sub-pads 183 and 242.

The second sub-pad 242 may be larger than the first sub-pad 183 such that it can entirely cover the first sub-pad 183. In this case, since the second sub-pad 242 prevents (or protects) the first sub-pad 183 and/or the main pad 122 from being exposed by a developing solution during a subsequent process, the battery phenomenon can be suppressed.

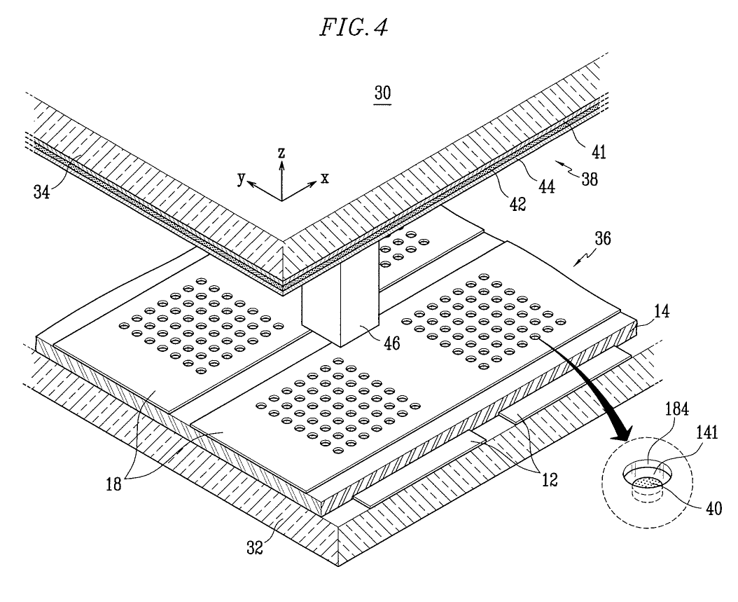

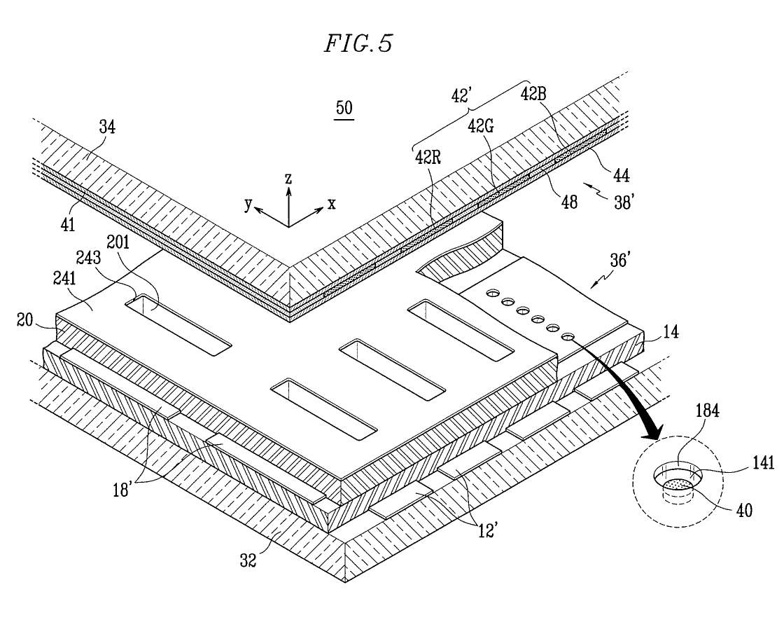

The light emission device manufactured by the methods according to the above described exemplary embodiments may be used as a light source for emitting white light to a passive type display panel or used as a display by itself by being provided with red, green and blue phosphor layers. The following will describe light emission devices each having the first electrode pads formed by the aforementioned methods according to a variety of embodiments of the present invention with reference to FIGS. 4 through 7.

FIG. 4 is a partially cut-away perspective view illustrating an internal structure of an active region in a light emission device, which can be used as a light source, according to an exemplary embodiment of the present invention.

Referring to FIG. 4, a light emission device 30 of the present exemplary embodiment includes first and second substrates 32 and 34 that face each other at an interval (that may be predetermined). A sealing member is provided at the peripheries (or periphery regions) of the first and second substrates 32 and 34 to seal them together, thereby forming a vacuum vessel. The interior of the vacuum vessel is exhausted and kept to a degree of vacuum of about 10⁻⁶ Torr. An electron emission unit 36 is located on an active region of an inner surface of the first substrate 32, and a light emission unit 38 is located on an active region of an inner surface of the second substrate 34.

The electron emission unit 36 includes a plurality of first electrodes 12, a plurality of second electrodes 18 crossing the first electrodes 12, an insulating layer 14 interposed between the first and second electrodes 12 and 18, and a plurality of electron emission regions 40 that are formed on the first electrodes 12 at each crossing region of the first and second electrodes 12 and 18. Openings 141 and openings 184, which correspond to the respective electron emission regions 40, are respectively formed in the insulating layer 14 and the second electrodes 18 to expose the electron emission regions 40 toward the second substrate 34. The first and second electrodes 12 and 18 correspond to (or are) the active portions as described above.

The first electrodes 12 function as cathode electrode(s) for applying current to the electron emission regions 40 and the second electrodes 18 function as gate electrode(s) that induce the electron emission by forming an electric field using a voltage difference from the cathode electrodes. In one embodiment, the first electrodes 12 function as scan electrodes applied with a scan driving voltage, and the second electrodes 18 function as data electrodes applied with a data driving voltage. In another embodiment, the second electrodes 18 function as scan electrodes applied with a scan driving voltage, and first electrodes 12 function as data electrodes applied with a data driving voltage.

The electron emission regions 40 may be formed of a material, which emits electrons when an electric field is applied thereto under a vacuum atmosphere, such as a carbonaceous material and/or a nanometer-sized material. For example, the electron emission regions 40 may be formed of carbon nanotubes, graphite, graphite nanofibers, diamonds, diamond-like carbon, fullerene C₆₀, silicon nanowires, or combinations thereof. Alternatively, the electron emission regions 40 may be formed to have a tip structure using Mo-based material and/or Si-based material.

In the above-described structure, each crossing region of the first and second electrodes 12 and 18 corresponds to one pixel region of the light emission device 30. Alternatively, two or more crossing regions correspond to one pixel region of the light emission device 30. In latter case, two or more first electrodes 12 and two and/or more second electrodes 18, which correspond to one pixel region, may be electrically interconnected to be applied with a common voltage.

The light emission unit 38 includes an anode electrode 41 and a phosphor layer 42 located on a surface of anode electrode 41. The phosphor layer 42 may be formed of a mixture of red, green and blue phosphors, which can emit white light. In this case, the phosphor layer 42 may be formed on an entire active region of the second substrate 34 or may be divided into a plurality of sections corresponding to the pixel regions.

The anode electrode 41 is formed by a transparent conductive material such as indium tin oxide (ITO). The anode electrode 41 is an acceleration electrode that pulls electrons emitted from the electron emission regions 40 toward the phosphor layer 42 by receiving a high voltage.

The phosphor layer 42 may be covered by a metal reflective layer 44. The metal reflective layer 44 functions to enhance the screen luminance by reflecting the visible light radiated from the phosphor layer 42 to the first substrate 32, back toward the second substrate 34. The anode electrode 41 can be omitted and the metal reflective layer 44 can receive the anode voltage instead of the anode electrode 41 (i.e., the metal reflective layer 44 can be (or function as) the anode electrode).

Disposed between the first and second substrates 32 and 34 are spacers 46 for uniformly maintaining a gap between the first and second substrates 32 and 34 even when external force (or pressure) is applied to the vacuum vessel. For simplicity reasons, only one pillar type spacer 46 is illustrated in FIG. 4.

The above-described light emission device 30 has a plurality of pixels formed by the combination of the first and second electrodes 12 and 18 and is driven by applying driving voltages (that may be predetermined) to the first and second electrodes 12 and 18 and by applying a positive direct current voltage (an anode voltage) from hundreds to thousands of volts to the anode electrode 41.

Electric fields are formed around the electron emission regions 40 at pixels where a voltage difference between the first and second electrodes 12 and 18 is equal to or higher than a threshold value and thus the electrons are emitted from the electron emission regions 40. The emitted electrons collide with the phosphor layer 42 of the corresponding pixel by being attracted by the anode voltage applied to the anode electrode 41, thereby exciting the corresponding portion of the phosphor layer 42. A light emission intensity of the phosphor layer 42 at each pixel corresponds to an emission amount of electron beams formed by the electrons of the corresponding pixel.

The first and second substrates 32 and 34 may be spaced apart from each other by a relatively large distance ranging from about 5 to 20 mm. By this relatively large distance between the first and second substrates 32 and 34, arcing in the vacuum vessel can be reduced and thus it becomes possible to apply a relatively high voltage that is above 10 kV, and, in one embodiment, from 10 to 15 kV, to the anode electrode 41. In the present exemplary embodiment, the light emission device 30 can realize a maximum luminance of about 10,000 cd/m² at a central region of the active region.

The number of pixels of the light emission device 30 may be less than that of a passive type display panel (for which the light emission device 30 provides light to) so that one pixel of the light emission device 30 can correspond to two or more pixels of the display panel. Each pixel of the light emission device 30 emits light in response to a highest gray level among the gray levels of the corresponding pixels of the display panel. Each pixel of the light emission device 30 can represent gray levels in gray scale ranging from 2 to 8 bits.

A display using the light emission device 30 as a light source can enhance a contrast ratio of the screen and reduce a motion blur (e.g., providing sharper images).

The light emission device 30 of this exemplary embodiment may have the first electrode pads formed through the method of the first exemplary embodiment of FIGS. 1A through 1H or the first electrode pads formed through the method of the second exemplary embodiment of FIGS. 2A and 2B.

FIG. 5 is a partially cut-away perspective view illustrating an internal structure of an active region in a light emission device, which is designed to be used as a display (e.g., a display by itself), according to another exemplary embodiment of the present invention. The light emission device of this second exemplary embodiment is a field-emission-array (FEA) type display.

Referring to FIG. 5, a light emission device 50 of the present exemplary embodiment includes an electron emission unit 36′ and a light emission unit 38′. A basic structure of the electron emission unit 36′ of the present exemplary embodiment is similar to that of the first exemplary embodiment except that the electron emission unit 36′ of the present exemplary embodiment further includes a second insulating layer 20 formed on the first insulating layer 14 to cover the second electrodes 18′ and a third electrode 241 formed on the second insulating layer 20.

The third electrode 241 functions as a focusing electrode. Openings 243 and openings 201 are respectively formed in the third electrode 241 and the second insulating layer 20. The third electrode 241 is applied with 0V or a negative direct voltage of several to tens of volts to converge (or focus) electrons on a central portion of a bundle of electron beams passing through the openings 243 of the third electrode 241.

The light emission unit 38′ includes red, green, and blue phosphor layers 42R, 42G, and 42B spaced apart from each other, a black layer 48 disposed between the phosphor layers 42′ to enhance the screen contrast, and an anode electrode 41 located on surfaces of the phosphor and black layers 42′ and 48.

Each crossing region of the first and second electrodes 12′ and 18′ corresponds to one of the red, green, and blue phosphor layers 42R, 42G, and 42B to define one sub-pixel. The three sub-pixels corresponding to the respective red, green, and blue phosphor layers 42R, 42G, and 42B that are successively arranged to define one pixel. The light emission device 50 controls a light emission intensity of a relevant phosphor layer by each sub-pixel to determine a light emission color for each pixel, thereby displaying a full-color image.

The light emission device 50 of this second exemplary embodiment may have the first electrode pads formed by the method of FIGS. 3A through 3C.

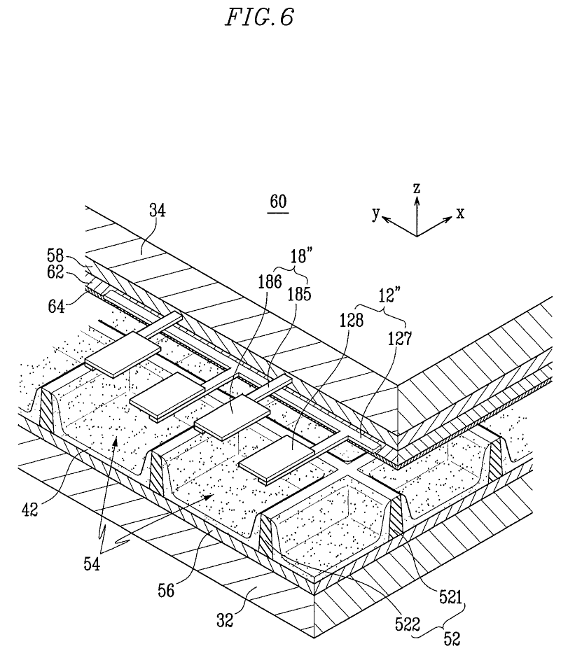

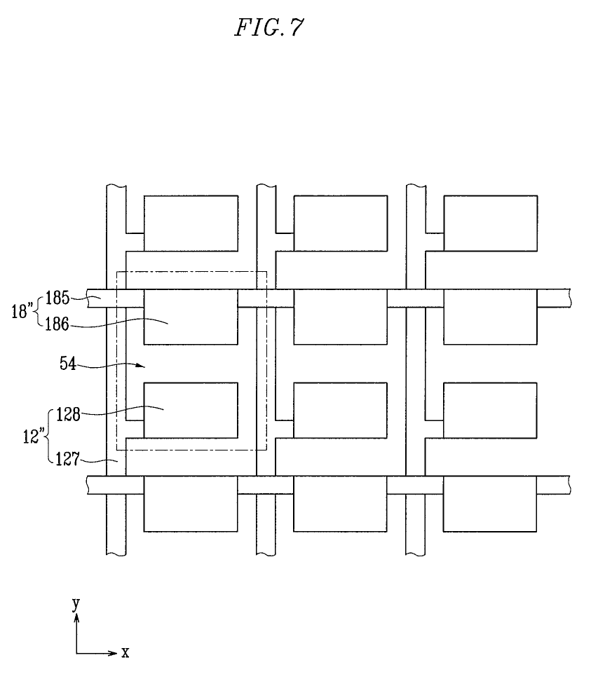

FIG. 6 is a partially cut-away perspective view illustrating an internal structure of an active region in a light emission device, which is designed to be used as a display (e.g., a display by itself), according to another exemplary embodiment of the present invention. FIG. 7 is a partial top plan view of first and second electrodes that are depicted in FIG. 6. A light emission device of this exemplary embodiment is a plasma display panel.

Referring to FIGS. 6 and 7, a light emission device 60 of the present exemplary embodiment includes first and second substrates 32 and 34 and barrier ribs 52 that are arranged between the first and second substrates 32 and 34 to define a plurality of discharge cells 54. Phosphor layers 42 for emitting visible light by absorbing ultraviolet rays are formed on the discharge cells 54 along inner surfaces of the barrier ribs 52 and a bottom surface of the first substrate 32. The discharge cells 54 are filled with discharge gas for a plasma discharge. A first dielectric layer 56 may be formed on an inner surface of the first substrate 32. The phosphor layer 42 in each discharge cell is one of red, green and blue phosphor layers.

The barrier ribs 52 include first barrier members 521 extending in a first direction (a y-axis in the drawings) of the first substrate 32 and second barrier members 522 extending in a second direction (an x-axis in the drawings) of the first substrate 32. In this case, the discharge cells 54 may be independently separated from each other. However, the present invention is not limited to this configuration. For example, only the first barrier members 521 may be provided to form open-type discharge cells.

First and second electrodes 12″ and 18″ are arranged on the second substrate 34 with a second dielectric layer 58 interposed therebetween. The first and second electrodes 12″ and 18″ cross each other. Portions of the respective first and second electrodes 12″ and 18″ face each other in each discharge cell 54 for a direct discharge. The second electrodes 18″ are covered with a third dielectric layer 62, and the third dielectric layer 62 is covered by a MgO passivation layer 64.

Each of the first electrodes 12″ includes a first bus electrode 127 extending in the first direction (the y-axis) and first transparent electrodes 128 extending from the first bus electrode 127 toward insides of the discharge cells 54. Each of the second electrodes 18″ includes a second bus electrode 185 extending in the second direction (the x-axis) and second transparent electrodes 186 extending from the second bus electrode 185 toward insides of the discharge cells 54. The second transparent electrodes 186 of the second electrode 18″ are spaced apart from the respective first transparent electrodes 128 of the first electrode 12″ by a distance (that may be predetermined) in the discharge cells 54, thereby defining a discharge gap.

During operation and in a reset period, the first electrodes 12″ are applied with a reset pulse. In an address period, the first electrodes 12″ are applied with a scan pulse. In a sustain period, the first electrodes 12″ is alternately applied with positive and negative sustain pulses. The second electrodes 18″ are applied with an address pulse in the address period and maintain a ground state in the reset and sustain periods. Then, in the address period, discharge cells that will be turned on are selected by an address discharge occurring by the scan pulse applied to the first electrode 12″ and the address pulse applied to the second electrode 18″ and the selected discharge cells 54 are sustain-discharged by the sustain pulse applied to the first electrode 12″.

The functions of the first and second electrodes 12″ and 18″ may be varied depending on a signal voltage applied thereto. That is, the present invention is not limited to the above-described driving configuration.

The above-described light emission device 60 selects the discharge cells 54, which will be turned on, by controlling the rest, address, and sustain periods using the first and second electrodes 12″ and 18″ and emits the visible light from the selected discharge cells 54. Therefore, only two circuit board assemblies for driving the first and second electrodes 12″ and 18″ are required and the manufacturing cost and time for manufacturing the circuit board assemblies for controlling the light emission device 60 can be reduced.

The light emission device 60 of this exemplary embodiment may have the first electrode pads formed by the method of FIGS. 1A through 1H or the first electrode pads formed by the method of FIGS. 2A and 2B.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method of manufacturing a light emission device, the method comprising:
forming a first electrode on a substrate to have an active portion and a main pad extending along a first direction of the substrate;
forming an insulating layer on the substrate while exposing at least a portion of the main pad;
forming a second electrode layer on an entire surface of the substrate; and
patterning the second electrode layer to form an active portion and a pad of a second electrode extending along a second direction of the substrate and to form a sub-pad on the main pad.

2. The method of claim 1, wherein the sub-pad is larger in area than the main pad.

3. The method of claim 1, wherein the main pad includes a main electrode layer and a sub-electrode layer covering the main electrode layer; and
the sub-electrode layer is larger in area than the main electrode layer.

4. The method of claim 3, wherein the main electrode layer is formed of a transparent conductive material; and
the sub-electrode layer is formed of chrome or chrome/aluminum/chrome.

5. The method of claim 1, wherein the second electrode layer is formed of chrome, molybdenum, and/or chrome/aluminum/chrome.

6. The method of claim 1, further comprising:
forming an additional insulating layer on the substrate while exposing at least a portion of the sub-pad;
forming a third electrode layer on an entire surface of the substrate; and
patterning the third electrode layer to form a third electrode on the additional insulating layer and to form an additional sub-pad on the sub-pad.

7. The method of claim 6, wherein the additional sub-pad is larger in area than the sub-pad.

8. A light emission device comprising:
a first substrate;
a second substrate facing the first substrate;
a first electrode located on a surface of the first substrate to face the second substrate and having a pad located on an edge portion of the surface of the first substrate;
a second electrode located over the first electrode with an insulating layer interposed therebetween, the second electrode crossing the first electrode; and
a phosphor layer located on a surface of the second substrate to face the first substrate,
wherein the pad of the first electrode includes a main pad and a sub-pad partly contacting the main pad and located on the main pad, the sub-pad comprising substantially a same material as the second electrode.

9. The light emission device of claim 8, wherein the sub-pad is larger in area than the main pad.

10. The light emission device of claim 8, wherein the main pad comprises a main electrode layer and a sub-electrode layer covering the main electrode layer; and
the sub-electrode layer is larger in area than the main electrode layer.

11. The light emission device of claim 10, wherein the main electrode layer comprises a transparent conductive material; and
the sub-electrode layer comprises chrome or chrome/aluminum/chrome.

12. The light emission device of claim 8, further comprising:
an additional insulating layer located over the second electrode;
a third electrode located on the additional insulating layer; and
an additional sub-pad located on the sub-pad, the additional sub-pad being larger in area than the sub-pad, and comprising substantially a same material as the third electrode.

13. The light emission device of claim 8, further comprising:
a plurality of electron emission regions located at a crossing region of the first electrode and the second electrode; and
an anode electrode located on a surface of the phosphor layer.

14. The light emission device of claim 13, wherein the phosphor layer is adapted to emit white light;
the first and second substrates are spaced apart from each other by a distance ranging from 5 to 20 mm; and
the anode electrode is applied with an anode voltage ranging from 10 to 15 kV.

15. The light emission device of claim 13, wherein the phosphor layer includes red, green and blue phosphor layers; and
a black layer is located between the red, green and blue phosphor layers.

16. The light emission device of claim 8, further comprising a plurality of barrier ribs located between the first and second substrates to define a plurality of discharge cells, wherein the discharge cells are filled with discharge gas.

17. The light emission device of claim 16, wherein the first electrode includes a first bus electrode extending in a first direction of the first and second substrates and a plurality of first transparent electrodes extending from the first bus electrode toward central portions of respective ones of the discharge cells; and
the second electrode includes a second bus electrode extending in a second direction of the first and second substrates and a plurality of second transparent electrodes extending from the second sub electrode toward central portions of respective ones of the discharge cells.

18. A light emission device comprising:
a substrate;
a first electrode located on a surface of the substrate and having an active portion and a pad, the pad being on an edge portion of the surface of the substrate;
a second electrode located over the first electrode and crossing the first electrode; and
an insulating layer interposed between the first electrode and the second electrode,
wherein the pad of the first electrode comprises a main pad and a sub-pad partly contacting the main pad and located on the main pad, the sub-pad comprising substantially a same material as the second electrode.

19. The light emission device of claim 18, further comprising:
a plurality of electron emission regions located at a crossing region of the first electrode and the second electrode; and
an anode electrode located over the first electrode and the second electrode, the anode electrode being for accelerating electrons emitted from the electron emission regions.

20. The light emission device of claim 18, further comprising:
a second substrate;
a phosphor layer located on a surface of the second substrate to face the first and second electrodes; and
a plurality of barrier ribs located with the phosphor layer on the surface of the second substrate to define a plurality of discharge cells,
wherein the discharge cells are filled with discharge gas for a plasma discharge.
